(19) United States
(12) Patent Application Publication
(10) Pub. No.: US 2008/0266747 A1
(43) Pub. Date: Oct. 30, 2008

(54) ELECTROSTATIC CHUCK

(75) Inventors: Norio Shiraiwa, Nagano-shi (JP); Takeshi Kobayashi, Nagano-shi (JP); Yuichi Hata, Nagano-shi (JP); Naoto Watanabe, Nagano-shi (JP)

Correspondence Address: DRINKER BIDDLE & REATH (DC), 1500 K STREET, N.W., SUITE 1100, WASHINGTON, DC, 20005-1209, US

(73) Assignee: SHINKO ELECTRIC INDUSTRIES CO., LTD., Nagano-Shi (JP)

(21) Appl. No.: 12/109,850

(22) Filed: Apr. 25, 2008

(30) Foreign Application Priority Data
Apr. 27, 2007 (JP) 2007-119380

(51) Int. Cl. H01T 23/00

(52) U.S. Cl. 361/234

(57) ABSTRACT

In an electrostatic chuck for chucking a glass substrate, the electrostatic chuck includes a pair of electrodes embedded in a ceramic material and interlaced with each other, where a volume resistivity of the ceramic material is 1×10⁸ Ωcm to 1×10¹⁴ Ωcm, a thickness of the ceramic material on a chucking surface side to cover the pair of electrodes is 100 μm to 200 μm, a pattern width of the pair of electrodes is 0.5 mm to 1 mm, and a minimum distance between the pair of electrodes is 0.5 mm to 1 mm.

This application is based on and claims priority from Japanese Patent Application No. 2007-119380, filed on Apr. 27, 2007, the entire contents of which are hereby incorporated by reference.

### BACKGROUND OF THE INVENTION

1. Technical Field

The present disclosure relates to an electrostatic chuck having a pair of electrodes.

2. Background Art

In recent years, a size of the flat-panel display (FPD) typified by the liquid crystal display device is increased, and the method and structure for stably-supporting a large-size glass substrate becomes important in the manufacturing steps of the FPD.

For example, the liquid crystal display device is manufactured in such a manner that two sheets of glass substrates on which a color filter, a thin film transistor array, etc. are provided are bonded together using a sealing member at an interval of about several microns and then the liquid crystal is filled in the interval and sealed in the two sheets of glass substrates.

A method of filling and sealing the liquid crystal are carried out under vacuum. More particularly, the sealing member is coated on either of two glass substrates to be pasted and also the liquid crystal is dropped onto either of the two glass substrates, then two sheets of glass substrates are bonded together while applying a pressure, thereby sealing the liquid crystal.

In such manufacturing steps of the FPD, the chucking method based on a static electricity (the electrostatic chuck) has been used as the method of supporting the glass substrate under vacuum (at a low pressure). However, unlike the conductor or the semiconductor such as the silicon wafer used as the semiconductor substrate, or the like, the glass substrate has no electric conductivity. Therefore, in order to obtain a sufficient chucking force, a high voltage must be applied to the electrostatic chuck.

When a high voltage is applied to the electrostatic chuck, various problems arise. For example, 1) the devices formed on the glass substrate may be damaged, 2) a circuit layout of the electrostatic chuck may be complicated, and 3) a discharge may be caused easily in the electrostatic chuck.

Therefore, various structures have been proposed for lowering a voltage applied to the electrostatic chuck (see e.g., JP-A-2005-223185).

However, according to the structure and conditions as described in JP-A-2005-223185, it is difficult for the electrostatic chuck to stably-chuck the glass substrate by an enough chucking force. Consequently, the electrostatic chuck having a new structure for chucking the glass substrate substantially stably has been demanded.

### SUMMARY OF THE INVENTION

Exemplary embodiments of the present invention are directed to a new and useful electrostatic chuck capable of solving the above problem, more particularly, to an electrostatic chuck capable of stably-chucking a glass substrate at a low applied voltage.

According to one or more aspects of the present invention, in an electrostatic chuck for chucking a glass substrate, the electrostatic chuck includes: a pair of electrodes embedded in a ceramic material and interlaced with each other, wherein a volume resistivity of the ceramic material is 1×10⁸ Ωcm to 1×10¹⁴ Ωcm, a thickness of the ceramic material on a chucking surface side to cover the pair of electrodes is 100 μm to 200 μm, a pattern width of the pair of electrodes is 0.5 mm to 1 mm, and a minimum distance between the pair of electrodes is 0.5 mm to 1 mm.

According to the present invention, the electrostatic chuck capable of stably-chucking the glass substrate at a low applied voltage can be provided.

### BRIEF DESCRIPTION OF THE DRAWINGS

FIG. 1 is a schematic sectional view of an electrostatic chuck according to an embodiment of the present invention;

FIG. 2 is a plan view showing an electrode structure of the electrostatic chuck in FIG. 1;

FIG. 3 is a view (#1) showing a result of a chucking force of the electrostatic chuck;

FIG. 4 is a view (#2) showing a result of the chucking force of the electrostatic chuck;

FIG. 5 is a view (#3) showing a result of the chucking force of the electrostatic chuck; and

FIG. 6 is a view (#4) showing a result of the chucking force of the electrostatic chuck.

### DETAILED DESCRIPTION

An exemplary embodiment of the present invention will be described with reference to the drawings hereinafter.

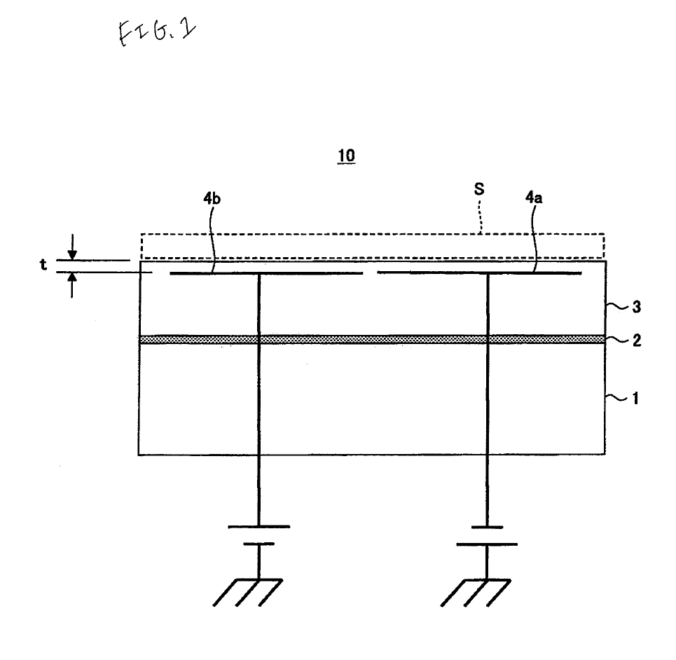

FIG. 1 is a schematic sectional view showing an electrostatic chuck according to an embodiment of the present invention. By reference to FIG. 1, an electrostatic chuck 10 according to the present embodiment has a supporting table 3 made of the ceramic material, and the supporting table 3 is bonded to a metal substrate 1 formed of the metal material such as Al, or the like, for example, via an adhesive layer 2 containing a resin material as a main component.

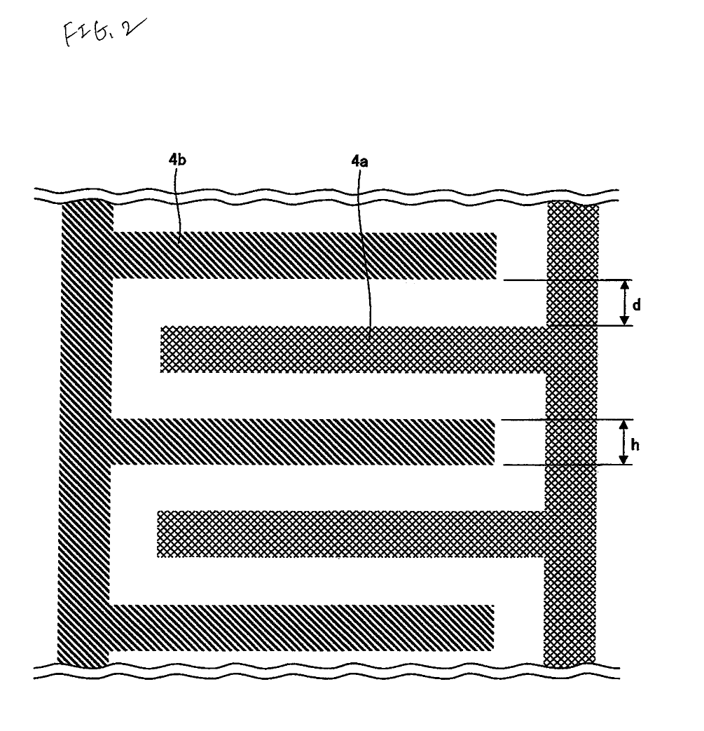

A pair of electrodes 4a, 4b may be made of a refractory metal such as W (tungsten), and is embedded in the ceramic material. As described later in FIG. 2, the pair of electrodes 4a, 4b are interlaced mutually and formed into comb teeth shapes. Also, the pair of electrodes 4a, 4b may be formed into a concentric circular shape, a spiral shape, or other shapes.

A glass substrate S as a chucked subject is disposed on the supporting table 3. When a voltage of one polarity and a voltage of another polarity are applied to the electrodes 4a, 4b respectively, the glass substrate S is electro-statically chucked onto the supporting table 3. However, in the electrostatic chuck in the related-art, when the chucked subject is made of the insulating material such as glass, a high voltage must be applied between the electrodes 4a, 4b to ensure a sufficient chucking force.

In some cases, for example, when a voltage applied between the electrodes 4a, 4b is increased, the devices such as TFTs (thin film transistors) formed on the glass substrate may be damaged. For example, as the driver of the display device, recently, the TFT using polysilicon is employed instead of the TFT using amorphous silicon.

The TFT using the polysilicon is more likely to be damaged by the applied voltage than the TFT using the amorphous silicon. Thus, when a voltage applied to the electrostatic chuck is large (e.g., about 4000 V to 5000 V), the TFT may be damaged remarkably.

Also, in some cases, a discharge may occur between the electrodes when a voltage applied to the electrostatic chuck is large. Also, a layout of the electrostatic chuck and that of the circuit that is resistant to a high voltage become complicated. Thus, a production cost of the electrostatic chuck is increased.

Accordingly, in the electrostatic chuck 10 according to the present embodiment, a stable chucking force (e.g., 2 gf/cm² or more) is produced by a lower applied voltage (e.g., 1000 V or less) than that in the related-art, and the electrostatic chuck 10 is characterized by following features.

First, the ceramic material constituting the supporting table 3 is made of a material that contains Al₂O₃ (alumina) as a main component. A volume resistivity of the ceramic material is 1×10⁸ to 1×10¹⁴ Ωcm at an ordinary temperature. A thickness t of the ceramic material constituting the supporting table 3 on the chucking surface side (on the surface side contacting the chucked subject) for covering the electrodes 4a, 4b (also referred simply to as a “thickness t” hereinafter) is set to 100 to 200 μm.

With the above configuration, as the chucking force generated between the supporting table 3 and the glass substrate S, a Johnsen-Rahbek force is dominant over a Coulomb force. Thus, the electrostatic chuck 10 is characterized as the so-called Johnsen-Rahbek type electrostatic chuck.

A chucking force of the Johnsen-Rahbek force is larger than that of the Coulomb force. Thus, this Johnsen-Rahbek force can be applied largely by reducing a volume resistivity of the ceramic material, which covers the electrodes 4a, 4b, and by reducing the thickness t of the ceramic material on the chucking surface side. Therefore, the Johnsen-Rahbek force is dominant in the chucking force.

In this case, when a volume resistivity of the ceramic material is reduced excessively, a discharge is likely to occur between the electrodes 4a, 4b and also a discharge is likely to occur between the electrodes and the chucked subject. Also, when the thickness t is reduced excessively, a discharge is likely to occur.

For this reason, in the electrostatic chuck 10 according to the present embodiment, the volume resistivity of the ceramic material constituting the supporting table 3 is set to 1×10⁸ to 1×10¹⁴ Ωcm (e.g., 1×10¹¹ Ωcm in the case of the present embodiment) and the thickness t of the ceramic material constituting the supporting table 3 on the chucking surface side, which cover the electrodes 4a, 4b, is set to 100 to 200 μm. As a result, a large chucking force can be achieved by increasing the Johnsen-Rahbek force, while a resistance voltage of the ceramic material can be maintained at a given value to suppress generation of a discharge.

Also, in order to increase the chucking force, the electrodes 4a, 4b may be configured such that a gradient force acts largely in addition to the Johnsen-Rahbek force. Next, configuration of the electrodes 4a, 4b will be described with reference to FIG. 2 hereunder.

FIG. 2 is a plan view showing an example of the configuration of the electrodes 4a, 4b of the electrostatic chuck 10 in FIG. 1. By reference to FIG. 2, the pair of electrodes 4a, 4b are formed into comb teeth shapes, and electrode patterns thereof are interlaced mutually. In the above configuration, a width h of a comb teeth pattern of the interlaced portions of the electrodes 4a, 4b (also referred simply to as an “electrode width h” hereinafter) may be set to 0.5 to 1 mm and a distance d between the adjacent comb teeth patterns of the interlaced portions of the electrodes 4a, 4b (also referred simply to as an “electrode interval d” hereinafter) may be set to 0.5 to 1 mm. For example, when the electrode interval d is made small, the gradient force can be enhanced but a risk of the discharge between the electrodes 4a, 4b is also enhanced. On the contrary, when the electrodes 4a, 4b are configured as above, the chucking force of the electrostatic chuck can be increased by increasing the applied gradient forced, while suppressing a risk of the discharge between the electrodes.

Also, in the manufacture of the liquid crystal display device, for example, when the electrostatic chuck is used to bond two sheets of large-size glass substrates together, such electrostatic chuck is used at a room temperature (about 25° C.). Also, it is preferable that the above electrostatic chuck is used in a relatively low temperature range below 200° C.

Also, when a surface roughness Ra of the chucking surface of the supporting table 3 is made small, the chucking force is increased. Therefore, it is preferable that the surface roughness Ra may be set to 1.5 μm or less. In the present embodiment, the surface roughness Ra is set to 0.8 μm, for example.

Next, the result of the chucking force of the electrostatic chuck will be described hereunder.

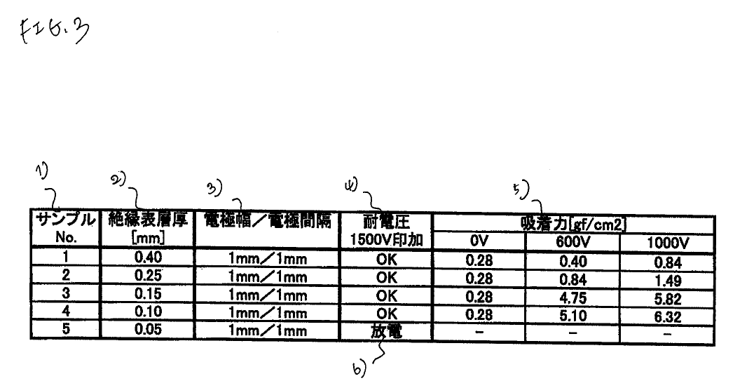

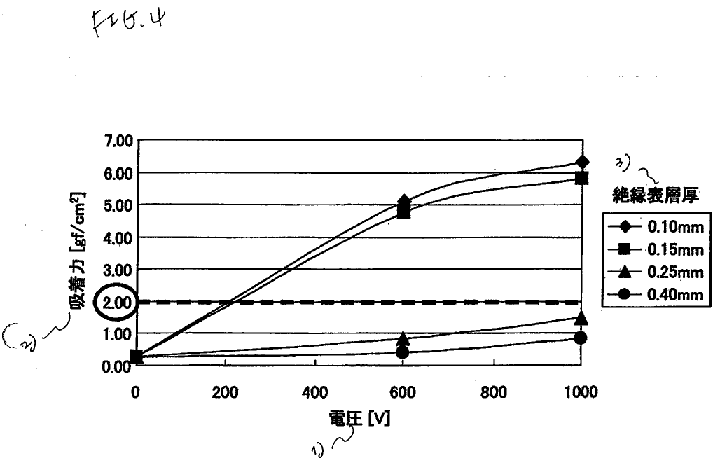

FIG. 3 is a view showing the result of the chucking force of the electrostatic chuck 10 shown in FIG. 1 and FIG. 2 when the thickness t of the ceramic material shown in FIG. 1 (shown as an “insulating surface layer thickness” in FIG. 3) is changed. In this case, the electrode width h and the electrode interval d are set to 1 mm respectively. Also, the test for checking the resistance voltage of the ceramic material is performed by applying a voltage of 1500 V between the electrode 4a and the electrode 4b. Also, FIG. 4 is a graph of the above result in FIG. 3.

By reference to FIG. 3 and FIG. 4, when the thickness t of the ceramic material is set to 250 μm (0.25 mm) or 400 μm (0.4 mm), the chucking force is caused mainly by the Coulomb force. Thus, the electrostatic chuck becomes the Coulomb type, and the chucking force is a small value (below 2 gf/cm²). In contrast, when the thickness t of the ceramic material is set to 100 μm (0.1 mm) or 150 μm (0.15 mm), the Johnsen-Rahbek force is dominant as the chucking force. Thus, the chucking force is 2 gf/cm² or more, and the electrostatic chuck can stably chuck the glass substrate.

Also, when the thickness t is set to 50 μm (0.05 mm), a discharge occurs in the electrostatic chuck. Thus, it is difficult for the electrostatic chuck to stably-chuck the glass substrate. As the above result, it is preferable that the thickness t is set to 100 μm to 200 μm. This is because the glass substrate can be chucked stably by the chucking force of 2 gf/cm² at a low applied voltage of 1000V or less, while suppressing generation of the discharge in the electrostatic chuck.

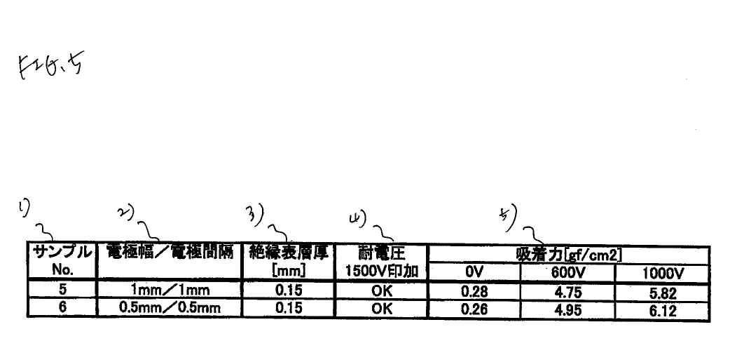

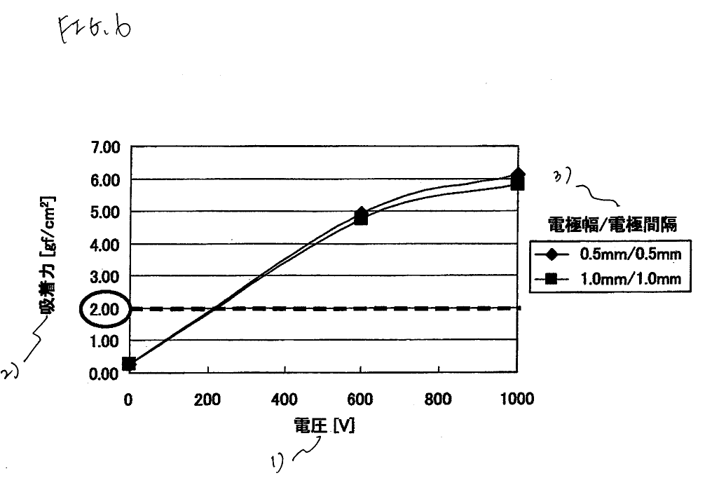

FIG. 5 is a view showing the result of the chucking force of the electrostatic chuck 10 shown in FIG. 1 and FIG. 2 when the electrode width h and the electrode interval d shown in FIG. 2 are changed. In the above case, the thickness t is set to 150 μm. Also, the test for checking the resistance voltage of the ceramic material is performed by applying a voltage of 1500 V between the electrode 4a and the electrode 4b. Also, FIG. 6 is a graph of the above result in FIG. 5.

By reference to FIG. 5 and FIG. 6, when the electrode width h is set to 0.5 to 1.0 mm and the electrode interval d is set to 0.5 to 1.0 mm, it is confirmed that the chucking force of 2 gf/cm² or more can be obtained and the glass substrate can be chucked with suppressing the discharge.

While the present invention has been shown and described with reference to certain exemplary embodiments thereof, it will be understood by those skilled in the art that various changes in form and details may be made therein without departing from the spirit and scope of the invention as defined by the appended claims. It is aimed, therefore, to cover in the appended claim all such changes and modifications as fall within the true spirit and scope of the present invention.

For example, the ceramic material constituting the supporting table 3 is not restricted to the material containing Al₂O₃ as a main component. For example, the ceramic material may contain AlN or SiC as a main component. Also, the ceramic material may contain various additive materials such as TiₓO_{y}, Cr, Ca, Mg, silica (SiO₂), and the like, which are used for adjusting a volume resistivity or an expansion coefficient during the burning.

What is claimed is:

1. An electrostatic chuck for chucking a glass substrate, the electrostatic chuck comprising:
a pair of electrodes interlaced with each other and embedded in a ceramic material,
wherein
a volume resistivity of the ceramic material is 1×10⁸ Ωcm to 1×10¹⁴ Ωcm,
a thickness of the ceramic material on a chucking surface side to cover the pair of electrodes is 100 μm to 200 μm,
a pattern width of the pair of electrodes is 0.5 mm to 1 mm, and
a minimum distance between the pair of electrodes is 0.5 mm to 1 mm.

2. The electrostatic chuck of claim 1, wherein a voltage applied between the pair of electrodes is 1000 V or less, and a chucking force is 2 gf/cm² or more.

3. The electrostatic chuck of claim 1, wherein the ceramic material contains Al₂O₃ as a main component.

4. The electrostatic chuck of claim 1, wherein the pair of electrodes is formed into a comb teeth shape, a concentric circular shape or a spiral shape.

5. The electrostatic chuck of claim 1, wherein a surface roughness Ra of the chucking surface of the ceramic material is 1.5 μm or less.
